(19) United States
(12) Patent Application Publication
(10) Pub. No.: US 2020/0338382 A1
(43) Pub. Date: Oct. 29, 2020

(54) MODULAR HOOP ILLUMINATED CONNECTOR

(71) Applicant: Kessler Corporation, Los Angeles, CA (US)

(72) Inventors: Alexander Kessler, Los Angeles, CA (US); Brian Kessler, Los Angeles, CA (US)

(21) Appl. No.: 16/857,760

(22) Filed: Apr. 24, 2020

Related U.S. Application Data
(60) Provisional application No. 62/838,507, filed on Apr. 25, 2019.

(51) Int. Cl. A63B 19/00; F21V 23/04; F21V 23/00; F21V 3/00; F21V 33/00

(52) U.S. Cl. CPC A63B 19/00; F21V 23/0492; F21V 23/007; F21V 3/00; F21V 33/008; F21Y 2115/10; A63B 2209/10; A63B 2220/801; A63B 2220/833; A63B 2220/17; A63B 2225/50; A63B 2207/02

(57) ABSTRACT

A modular play and/or exercise hoop having a tear-drop shaped cross section that includes tube segments that are attached to each other by connectors into a circular ring. The connectors have an illumination circuit that project light into each tube segment.

### FIELD OF INVENTION

The present invention relates to play and/or exercise hoops.

### BACKGROUND

Play and exercise hoops, often referred to as “hula hoops” for rotation about the body are widely known and used for gyrating around the hips and other parts of the body. These hoops are typically made from a length of plastic tubing having a circular cross-section. The tubing is shaped in a circle and the ends are joined to form the hoop.

Many people have difficulty learning to use these types of hoops. This can be for a variety of reasons but inevitably the circular hoop slips down past the user's hips and falls to the ground. The process can be frustrating, particularly for the beginner.

Hula hooping primarily occurs around the waist resulting in a great core work out. Regular hooping can strengthen waist and stomach muscles including the abdominal muscles (upper and lower) and back muscles. More broadly, waist hooping can use nearly thirty different muscles and can burn approximately 400 calories per hour.

Hoops can have lighted elements for entertainment value and/or use in dimly lit areas.

### SUMMARY OF INVENTION

The present invention is directed to a play and/or exercise hoop.

In one general aspect, a modular hoop includes tube segments having a tear-drop shaped cross section, connectors inserted into a portion of each tube segment to configure the tube segments into a circular ring, and an illumination circuit in each connector that projects light into each tube segment.

Embodiments may include one or more of the following features. For example, when the tube segments are connected into a circular ring the modular hoop has an axis of symmetry that is parallel to a central axis of the hoop.

As another feature, the tube segments can have an iridescent coating or film attached to the outer surface of the tube segments.

The connectors may have a center portion with ribbed portions at each end that attach to a connector portion such that each connector portion and ribbed portion are received within each tube segment and the center portion becomes part of the perimeter of the modular hoop. The connectors may have a teardrop shaped cross-section configured to be press fit into each teardrop shaped tube segment. An adhesive may be applied to the connector portion and/or the ribbed portion.

The illumination circuit may have an electronic circuit or circuit board disposed within the center portion of the connector and a lighting element connected to the circuit board and positioned within the ribbed portion and/or the connector portion. The electronic circuit may also have a motion sensor to actuate the lighting element. The motion sensor may send a signal to a processor of the electronic circuit to provide illumination from each lighting element in a predetermined pattern. The electronic circuit may also have a counter that measures the number of swings or rotations of the modular hoop. A Bluetooth transmitter may be incorporated to transmit data between the circuit and an external device, such as, for example, a computer or a smart phone.

A reflector may be positioned between the circuit board and each lighting element. A light diffuser may also be used to disperse light into the tube segment.

As another feature, an iridescent film may be bonded to an outer surface of each tube segment to accent a base color of each tube segment.

Each teardrop shaped tube segment may include angled inner and outer all, attached in a v-shaped cross-section with a rounded top-portion attached to a top edge of the inner and outer wall.

In another general aspect, a circular hoop includes a plurality of tube segments, each tube segment comprising an inner wall and an outer wall each having a top edge and a bottom edge, wherein the bottom edge of the outer wall is attached to the bottom edge of the inner wall to define a V-shaped angle relative to a central axis of the hoop and a rounded top-portion attached to the top edge of the inner wall and a top edge of the outer wall, a plurality of connectors, each connector inserted into a portion of each tube segment to configure the more than one tube segment into a circular ring, and an electronic circuit in each connector that projects light into each tube segment. Embodiments may include one or more of the above or following features.

In still another general aspect, a play and/or exercise hoop includes an inner wall having a top edge and a bottom edge and an outer wall having a top edge and a bottom edge. The bottom edge of the outer wall is attached to the bottom edge of the inner wall to define a bottom edge of the hoop. A rounded top-portion is attached to the top edge of the inner wall and a top edge of the outer wall. A lighting circuit with a motion sensor is disposed within the hoop.

Embodiments may include one or more of the above or following features. For example, a first plane defining the surface of the inner wall and a second plane defining a surface of the outer wall are at an angle relative to a central axis of the hoop. The inner wall and the outer wall define a v-shaped configuration extending from the bottom edge of the hoop to the attachment with the rounded top-portion.

The inner wall of the hoop may have a high friction surface that makes contact with the user thereby helping to prevent the hoop from slipping down the body of the user.

The hoop may be a continuous circle made from a tube segment that is joined together. Thus, it may typically be hollow.

The hoop may have an iridescent film or transparent film bonded to its outer surfaces.

The inner wall and/or the outer wall may be flat and angled relative to a central axis of the hoop. The angle of the inner wall creates increased surface area and additional friction between the hoop and the user. By “flat”, what is meant is a surface which is flat in cross-section even though curved about the hoop.

### DESCRIPTION OF THE DRAWINGS

FIG. 1 shows a perspective view of a hoop with a rounded top-portion facing up in accordance with the present invention;

FIG. 2 shows a side view of the hoop of FIG. 1;

FIG. 3 shows a cross-sectional view of the hoop along lines A-A of FIG. 1;

FIG. 4 is a perspective view of the hoop of FIG. 1 with the rounded portion facing down;

FIG. 5 shows a user playing with the hoop;

FIG. 6 shows a cross-section of the hoop in relation to the trunk of the user;

FIG. 7 is another embodiment of a cross-section of the hoop; and

FIG. 8 is a connector that joins both ends of a segment of tubing to form the hoop.

FIG. 9 shows an embodiment of a modular hoop with multiple connectors and tube segments;

FIG. 10 is a connector for the embodiment shown of FIG. 9;

FIG. 11 is a tube segment of the embodiment of FIG. 9;

FIG. 12 shows the connector and tube segments of FIG. 9;

FIGS. 13-15 show lighting circuits of the connector of FIG. 10;

### DETAILED DESCRIPTION OF EMBODIMENTS

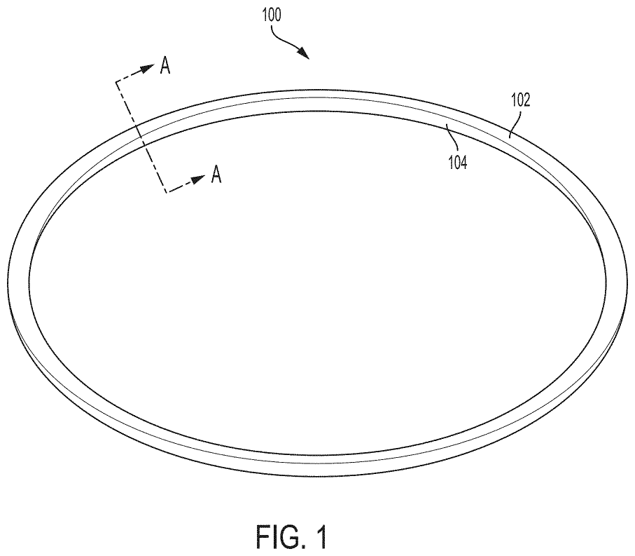

Referring to FIGS. 1-4, a hoop 100 includes a rounded top portion 102 that is attached to an inner wall 104 and an outer wall 106 that converge to a V-shaped bottom edge 108. The hoop is formed from a length of tubing that is bent into a circular shape and the two ends joined (not shown).

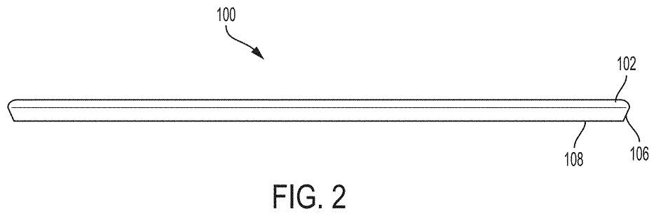

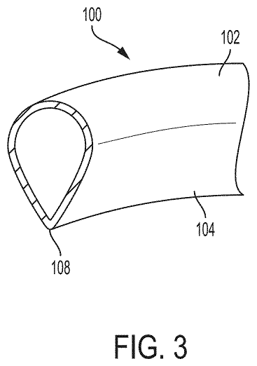

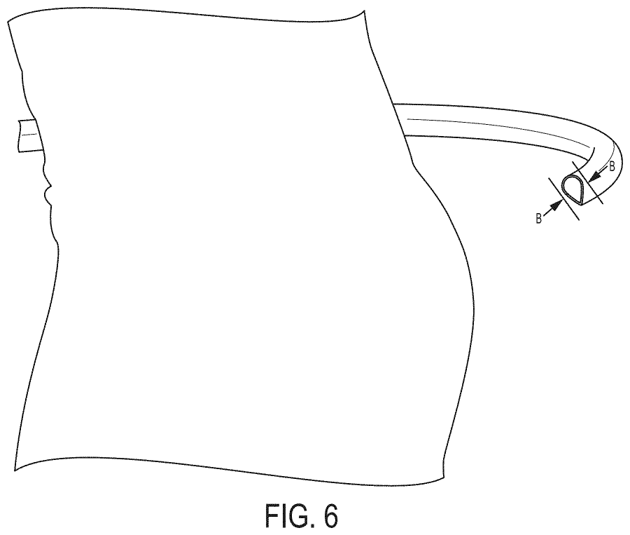

FIG. 2 is a side view of the hoop 100 showing the rounded top portion 102, the outer a 106 and the V-shaped bottom edge 108. FIG. 3 is a cross-sectional view of the hoop 100 along the line A-A of FIG. 1. The rounded top portion 102 is attached to the inner wall 104 that converges to the bottom V-shaped edge 108. Referring to FIG. 6, the inner wall 104 and the outer wall 106 have a dimension of approximate ¾ of an inch as shown by Dimension B. In other embodiments the inner and outer walls 104, 106 may have dimensions ranging from 0.5-1.0 inches. As shown, the hoop is hollow, however, in different embodiments the inside of the hoop may be a solid composition or may be filled with solid matter, such as, for example, water or a counter-weight.

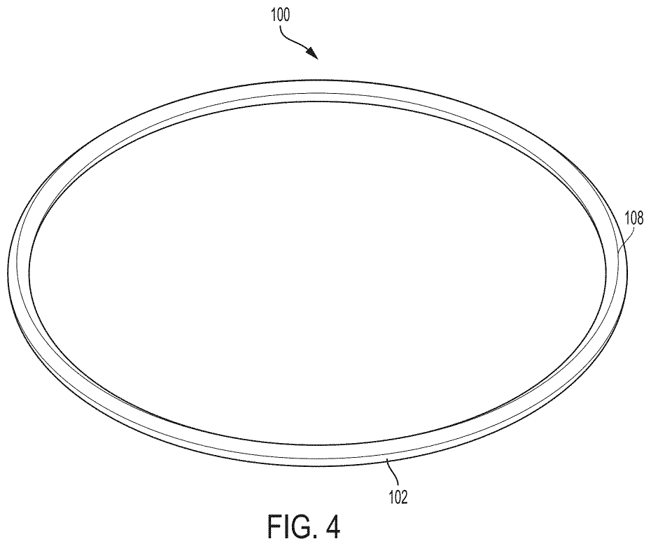

FIG. 4 is a perspective view of the hoop 100 with the V-shaped edge 108 facing up and the rounded portion 102 facing down.

The hoop 100 is formed from a semi-rigid plastic, such as, for example, extruded polyethylene or polyethylene terephthalate glycol, the latter being a type of thermoplastic polyester. The thickness of the hollow hoop 100 may depend on a desired weight and amount of rigidity. The diameter of the hoop 100 may range from 32-39 inches for youth or advanced adult hoopers. Mid-size hoops 100 may be approximately 36-42 inches in diameter. Large hoops 100 are typically 42 inches or larger. However, the diameter of the hoop can vary significantly based on the height and ability of the user. Typically, hoops 100 may weigh from about 0.2 to 2.5 pounds.

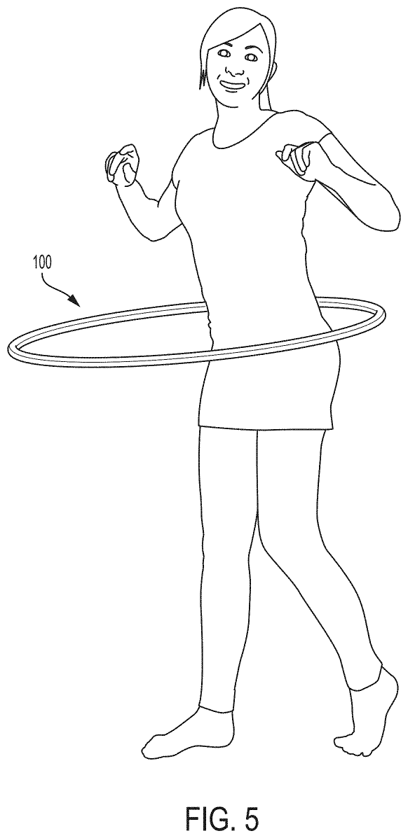

Referring to FIG. 5, the user can grab around the ergonomic V-shape of the hoop 100 and rotate it around her hips. The user continues the momentum of the hoop by moving her hips and midsection in a front to back, side to side or push-pull motion which maintains the hoop in a circular motion.

As shown in FIG. 6, the inner wall 104 rides along the user's hips. In the embodiment as show, the inner wall 104 is flat instead and angled to mate with a larger area of the user's hips, there is additional surface friction between the user and the inner flat wall 104 of the hoop. The surface friction may also be enhanced with a roughened surface, a fabric, friction tape and/or rubberized hemispherical bumps bonded to the inner flat wall 104 (not shown).

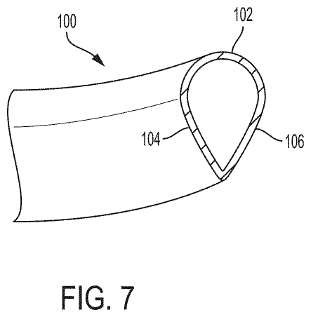

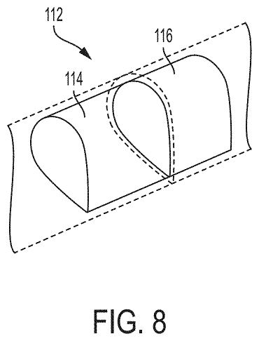

In another embodiment as shown in FIG. 7, the inner wall 104 and the outer wall 106 have a slight curve relative to the top portion 104 thereby defining a teardrop cross-sectional view. Once again, the teardrop shape of the inner wall 104 creates more surface area in contact with the body of the user. Referring to FIG. 8, a connector 112 is used to attach the two ends of a segment of tubing to form the hoop 100. The connector has a first end 114 and a second end 116 and a rib 118 between the first and second ends 114, 116. The two ends of a tube segment are pushed onto the first and second end 114, 116 and butt up against the rib 118. The ends 114, 116 are then bonded or glued in place.

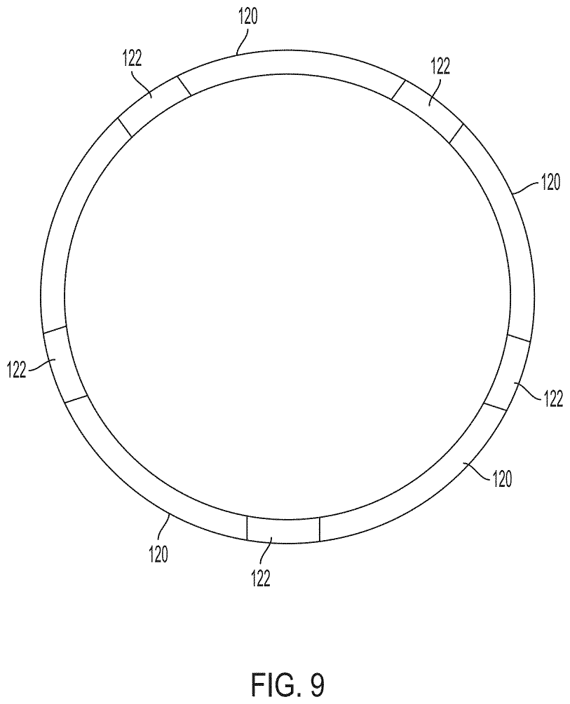

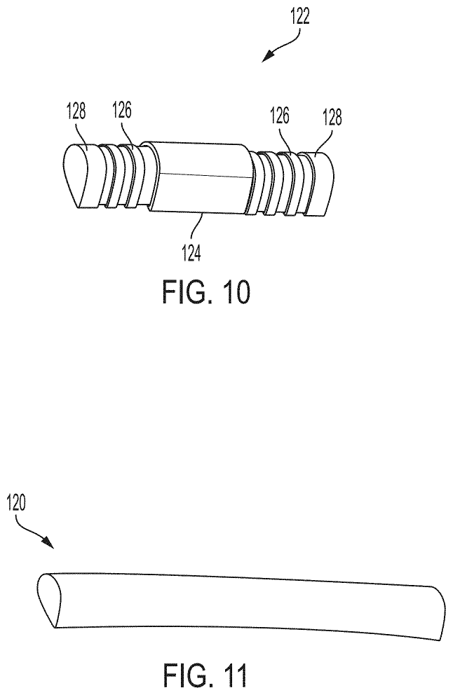

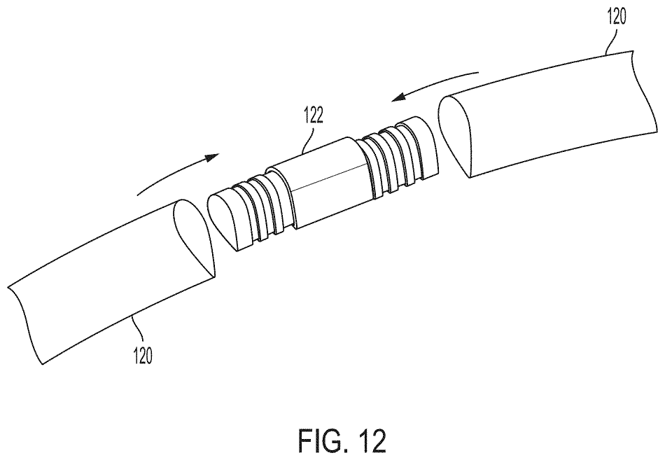

FIGS. 9-12 show an embodiment of a modular hoop with multiple tube segments 120 and connectors 122. As shown, the hoop has five tube segments 120 and five connectors plugs 122. The connector has a center portion 124, ribbed portions 126 and connector portions 120.

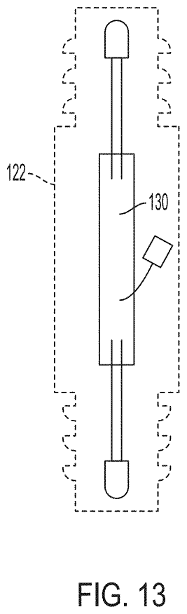

The hoop tube segments 120 are pressed onto the connector 122 as shown by the arrows in FIG. 12. Once pressed into position, the ribbed portions 126 help to prevent the connector from sliding back out and the connector portions 128 create a solid surface against the surface of the tube segment 120.

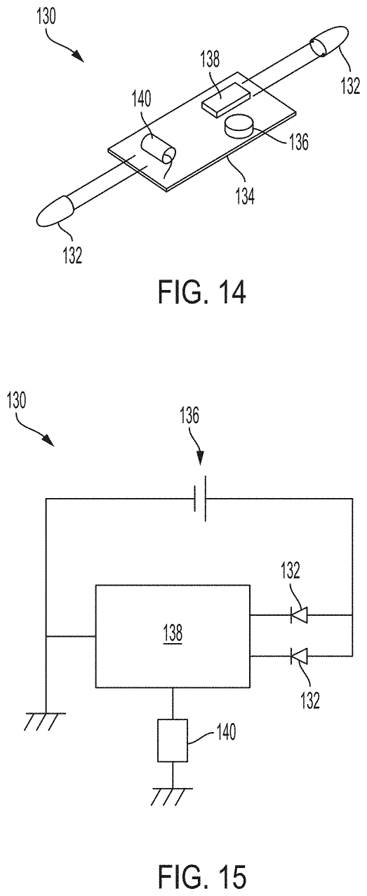

FIGS. 13-15 show a lighting circuit 130 inside a connector 122. The lighting circuit includes a pair of LEDs 132, a printed circuit board, 136, batteries 136, an integrated circuit 138 and an impact switch 140.

The LEDs extend away from the electronic circuit board or printed circuit board and are positioned in a channel inside the connector. The LEDs may be electrically attached to the circuit board by wires or flexible conductive strips or rods.

A vibration force causes a metal component or spring of the impact switch 140 to move causing it to intermittently create a conductive path but touching a metal contact. The impact switch 24 sends a signal to the integrated circuit 138 to trigger the LEDs subject to a predetermined flashing mode for a predetermined length of time.

An iridescent or pearlescent coating or film may be bonded to the inside or the outside of the hoop. The iridescent film is transparent so that it accents or enhances the base color of the hoop. The hoop may have internal lighting and the film can create shimmering, wavering colors as the angle of view or angle of illumination changes. The film may be about 10-30 microns in thickness and it can contain multiple layers of different polymers.

Other types of films may be used for different effects. For example, the film may give the modular hoop a prismatic, rainbow-like, kaleidoscopic, opalescent, pearlescent shimmering, glittering or sparkling appearance. In one embodiment, the combination of film and lighting may project various patterns onto other surfaces.

The illumination circuit or light emitting circuit assembly 20 comprises a battery 21 that provides the necessary working voltage, a plurality of LEDs (light emitting diodes) 22, and an impact switch 23 electrically connected between the battery 21 and the LEDs 22. The impact switch 23 is comprised of a metal casing 24 and a metal spring 25. The metal casing 24 is connected to one terminal, for example, the positive terminal of the battery 21 by a conductor 27. The metal spring 25 is suspended inside the metal casing 24, having one end inserted through an electrically insulative pad 240 in the metal casing 24 and connected to the other terminal, namely, the negative terminal of the battery 21 by a conductor 26.

The above description of various embodiments reveals the general nature of the invention so that others can readily modify and/or adapt for various applications other embodiments without departing from the concept, and, therefore, such adaptations and modifications are within the scope of the claims and equivalents. The terminology used herein is for the purpose of description and not of limitation. The means, materials, and steps for carrying out various disclosed functions may take a variety of alternative forms without departing from the invention.

1. A modular hoop, comprising:
more than one tube segment;
more than one connector inserted into a portion of each tube segment to configure the more than one tube segment into a circular ring; and
an illumination circuit in each connector that projects light into each tube segment.

2. The modular hoop of claim 1, wherein the hoop comprises a teardrop shaped cross section.

3. The modular hoop of claim 2, wherein the teardrop shaped cross-section comprises an axis of symmetry that is parallel to a central axis of the hoop

4. The modular hoop of claim 1, wherein each tube segment comprises an iridescent coating.

5. The modular hoop of claim 1, further comprising an iridescent film applied to an outer surface of each tube segment.

6. The modular hoop of claim 1, wherein each connector comprises a center portion attached to ribbed portions attach to a connector portion, wherein each connector portion and ribbed portion are received within each tube segment and the center portion comprises a perimeter of the modular hoop.

7. The modular hoop of claim 6, wherein each connector comprises a teardrop shaped cross-section configured to be press fit into each teardrop shaped tube segment.

8. The modular hoop of claim 6, further comprising an adhesive on the connector portion and/or the ribbed portion.

9. The modular hoop of claim 6, wherein the illumination circuit comprises an circuit disposed within the center portion of the connector and a lighting element connected to the circuit board and positioned within the ribbed portion and/or the connector portion.

10. The modular hoop of claim 9, wherein the electronic circuit further comprises a motion sensor to actuate the lighting element.

11. The modular hoop of claim 10, wherein the motion sensor sends a signal to a processor of the electronic circuit to provide illumination from each lighting element in a predetermined pattern.

12. The modular hoop of claim 6, wherein the electronic circuit further comprises a counter that measures the number of swings or rotations of the modular hoop.

13. The modular hoop of claim 6, further comprising a reflector between the electronic circuit and each lighting element.

14. The modular hoop of claim 6, further comprising a light diffuser.

15. The modular hoop of claim 1, further comprising an iridescent film bonded to an outer surface of each tube segment that accents a base color of each tube segment.

16. A circular hoop, comprising:
a plurality of tube segments;
a plurality of connectors, each connector inserted into a portion of each tube segment to configure the more than one tube segment into a circular ring; and
an illumination circuit in each connector that projects light into each tube segment.

17. The circular hoop of claim 16, wherein the illumination circuit comprises an electronic circuit board mounted in a center of the connector and lights that extend away from the electronic circuit board toward each end of the connector to project light into each tube segment.

18. The circular hoop of claim 17, wherein the lights comprise light emitting diodes.

19. The circular hoop of claim 17, further comprising a reflector to project light into each tube segment.

20. The circular hoop of claim 16, wherein each tube segment comprises an inner wall and an outer wall each having a top edge and a bottom edge, wherein the bottom edge of the outer wall is attached to the bottom edge of the inner wall to define a V-shaped angle relative to a central axis of the hoop and a rounded top-portion attached to the top edge of the inner wall and a top edge of the outer wall.
